(19) United States
(12) Patent Application Publication
(10) Pub. No.: US 2012/0312944 A1
(43) Pub. Date: Dec. 13, 2012

(54) Sign Holder and Coupon Dispenser

(76) Inventor: Christopher S. Anderson, Westport, CT (US)

(21) Appl. No.: 13/157,441

(22) Filed: Jun. 10, 2011

(51) Int. Cl. G09F 7/18

(52) U.S. Cl. 248/222.14

(57) ABSTRACT

A system for mounting a sign on a store shelf comprises a mounting bracket for mounting a sign holder to the C-channel commonly found on the edge of shelves. The mounting bracket has a mounting face coupled to a channel anchor. The sign holder is affixed to the mounting face and the channel anchor is affixed to the C-channel. The mounting face and channel anchor are pivotably coupled to allow the angle there between to be adjustable. Bumps on the channel anchor and corresponding dimples on the mounting face may be provided to allow adjustment of the angle when a mounting screw is loosed and locking in of the angle when the mounting screw is tightened.

### FIELD OF INVENTION

This invention is in the field of store displays.

### COPYRIGHT NOTICE

A portion of the disclosure of this patent document contains material to which a claim for copyright is made. The copyright owner has no objection to the facsimile reproduction by anyone of the patent document or the patent disclosure as it appears in the Patent and Trademark Office patent file or records, but reserves all other copyright rights whatsoever.

### BACKGROUND

Placing sign holders and coupon dispensers on the shelves of stores can be difficult. The sign holders and coupon dispensers need to be attractive, easy to set up, easy to remove, inexpensive produce, rugged enough to withstand normal abuse and adaptable enough to work on a wide variety of shelf designs.

### SUMMARY OF INVENTION

The Summary of the Invention is provided as a guide to understanding the invention. It does not necessarily describe the most generic embodiment of the invention or all species of the invention disclosed herein.

FIG. 1 illustrates an exemplary embodiment of a sign holder 1000 suitable for mounting on a typical store shelf 1010. The sign holder comprises a gripper 1002, an arm 1004 and a mounting bracket 2030 (FIG. 2A). Referring back to FIG. 1, the mounting bracket comprises tabs 1006 which engage holes 1012 typically found on many store shelves. The gripper can be open and closed using a screw 1009. This allows a sign 1020 to be easily inserted or removed when the gripper is open. When the gripper is closed, the sign is held securely.

The mounting bracket can also be designed to engage a “C” channel 1014 commonly found on the edge of shelves. C-channels are normally used to hold product identification and/or pricing labels. They may be made of extruded materials such as aluminum or plastic.

### BRIEF DESCRIPTION OF FIGURES

FIG. 1 is a perspective drawing of a sign holder mounted on a shelf and holding a sign.

FIG. 2A is a perspective drawing of a sign holder.

FIG. 2B is an exploded view of the sign holder of FIG. 2A.

FIG. 3 is a perspective view of a mounting bracket.

FIG. 4A is a perspective view of a coupon dispenser.

FIG. 4B is an exploded view of the coupon dispenser of FIG. 4A.

FIG. 5A is a perspective view of a door mounted sign holder.

FIG. 5B is an exploded view of the door mounted sign holder of FIG. 5A.

FIG. 6A is a perspective view of a C-channel mounting bracket.

FIG. 6B is an exploded view of the C-channel mounting bracket of FIG. 6A.

FIG. 7 is a side view of a sign holder mounted on the C-channel of a tilted shelf.

### DETAILED DESCRIPTION OF INVENTION

Persons of ordinary skill in the art will realize that the following disclosure is illustrative only and not in any way limiting. Other embodiments of the disclosure will readily suggest themselves to such skilled persons having the benefit of this disclosure.

### Sign Holder for Mounting on Shelf Holes

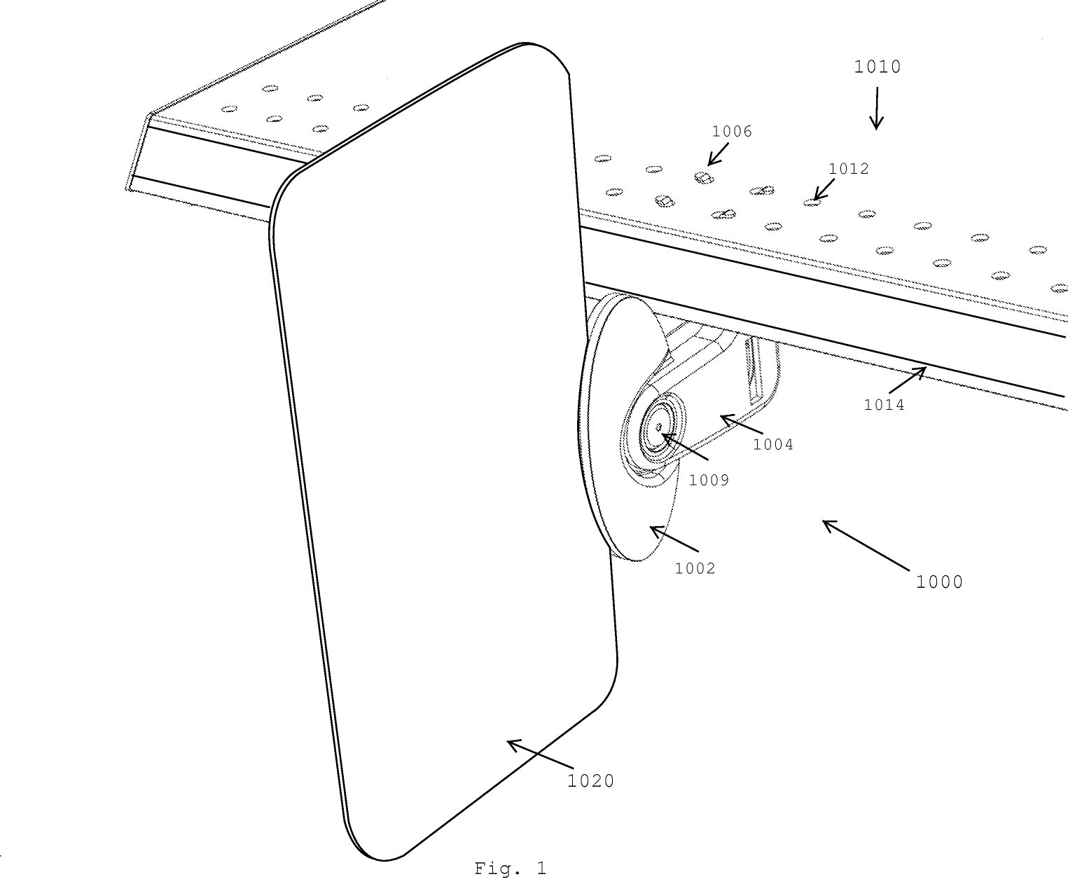

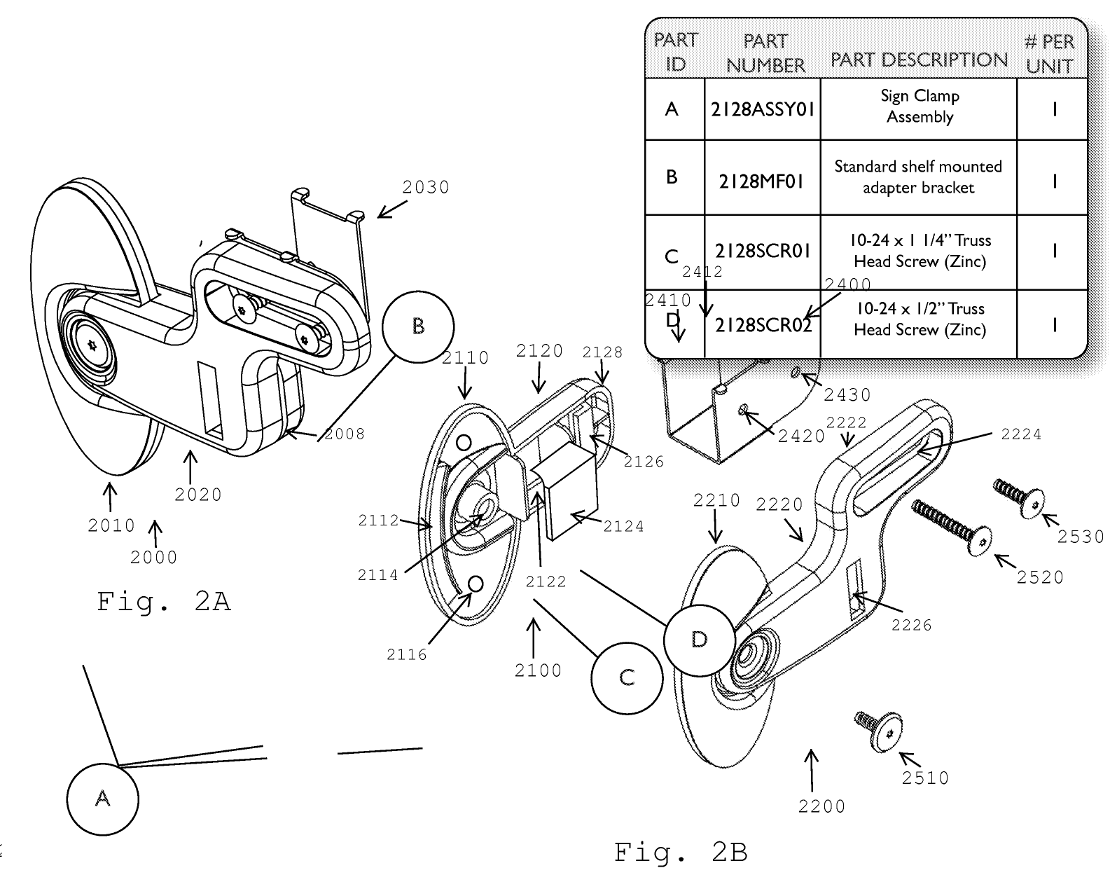

FIG. 2A a perspective view of the sign holder shown in FIG. 1. The sign holder 2000 comprises a gripper 2010, an arm 2020 and a mounting bracket 2030.

FIG. 2B shows an exploded view of the sign holder of FIG. 2A. The gripper and arm are unitary but split down the middle. The gripper/arm comprises a mounting half 2200 and an engagement half 2100. Suitable materials of construction include a strong, attractive polymer, such as black polycarbonate. Any material of similar minimum strength, durability and attractiveness may be used.

The gripper halves 2110 and 2210 have an attractive yet functional oval-shape. Suitable dimensions for the gripper halves are 4.25 inches high by 2.09 inches wide by 0.5 inched deep. Any dimension or shape may be used, however, that is suitable for holding an intended sign.

Each gripper half may comprise a flat shelf 2112 for mounting an elastomeric pad on. The opposing elastomeric pads would help hold the intended sign. Pins 2116 may also be provided to engage mounting slots cut in the sign. The slots would slip over the pins and provide additional holding support.

A cylinder shaped cup 2114 may be provided to hold a threaded metal barrel. This would receive a clamping screw 2510. The clamping screw would be used to open and close the two gripper halves.

The arm 2120 of the engagement half may comprise a chamber 2122 for receiving a compressible closed cell foam pad 2124. The foam pad would press against the corresponding wall of the arm of the mounting half when the two halves were assembled. The pad would push the gripper halves open when the clamping screw is loosened. Any suitable spring or compressible device may be used.

The arm of the engagement half additionally comprises a forward-facing L-shaped tab 2126. This mates with a corresponding rear facing L-shaped tab 2226 (partially obscured) in the mounting half. The L-shaped tabs engage each other when the engagement half and mounting half are assembled.

The rear edge of the engagement half is slightly scalloped 2128 so that a gap 2008 (FIG. 2A) is formed when the engagement half and mounting half are assembled. The gap allows the two halves to pivot about the L-shaped tabs when the clamping screw is loosened to open the gripper halves.

The arm 2220 of the mounting half doglegs to form an upper mounting slot 2222. The mounting slot is dimensioned to receive a long bracket screw 2520 and a shorter positioning screw 2530. The mounting slot has a lower shelf 2224 (partially obscured) for supporting the heads of the bracket and positioning screws.

The bracket screw and the positioning screw attach the mounting half of the gripper/arm to the mounting bracket 2400. The mounting bracket has a square U shape. It can be made out of metal, such as 18 gauge galvanized steel. Any material with comparable strength, ductility, corrosion resistance and suitable aesthetics may be used. Tabs 2412 are provided to engage corresponding holes in the self to be mounted on (1012 FIG. 1). Four tabs are suitable. 0.18 inch diameter tabs spaced 1 inch apart are suitable for standard store shelves in the US. Mounting brackets with dimensions that correspond to standard store shelves in other locations may be provided.

The height of the mounting bracket may be 1.5 inches. This allows enough lateral flex in the side walls of the bracket so that it may be spread and locked into place when the bracket screw is tightened.

When the mounting half is mounted on the bracket, the position is adjusted and the positioning screw is tightened in the corresponding positioning screw hole 2430 on the mounting bracket. The positioning screw hole may my extruded inwardly and threaded. Threaded barrels may alternatively be attached to the holes. Other threaded means may also be used.

The bracket screw is then screwed through the corresponding threaded bracket screw hole 2420. It is screwed in until it traverses across the mounting bracket and engages the opposite wall 2410. It is then tightened in order to spread the walls apart thus locking the mounting bracket in place.

In order to remove the mounting bracket from the shelf, the bracket screw is loosened and the U shape returns to its unexpanded shape and the tabs can fit back through the holes in the shelf.

Thus an inexpensive, robust, attractive and easy to use mounting bracket for a sign holder for a store shelf is provided.

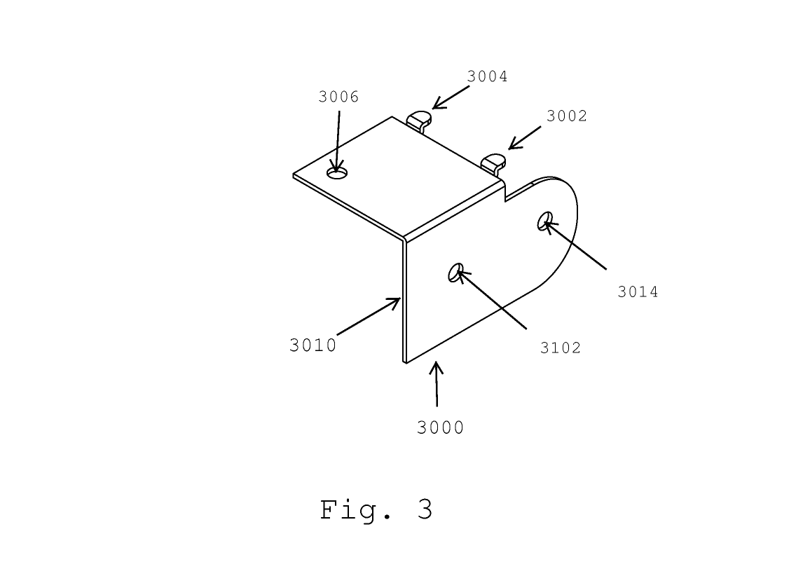

FIG. 3 illustrates an L-shaped mounting bracket 3000. The L-shaped mounting bracket comprises two tabs 3002, 3004 that fit into corresponding holes in a shelf. A treaded hole 3006 is provided to receive a corresponding shelf screw. The L-shaped mounting bracket is mounted under a shelf by engaging the tabs in the holes of the shelf and then passing the shelf screw through a hole in the shelf and screwing in the screw into the threaded hole. The mounting half of a sign holder (FIG. 2B) is then attached to the mounting holes 3012, 3014 on the vertical wall 3010 of the bracket.

### Coupon Holder for Mounting on Shelf Holes

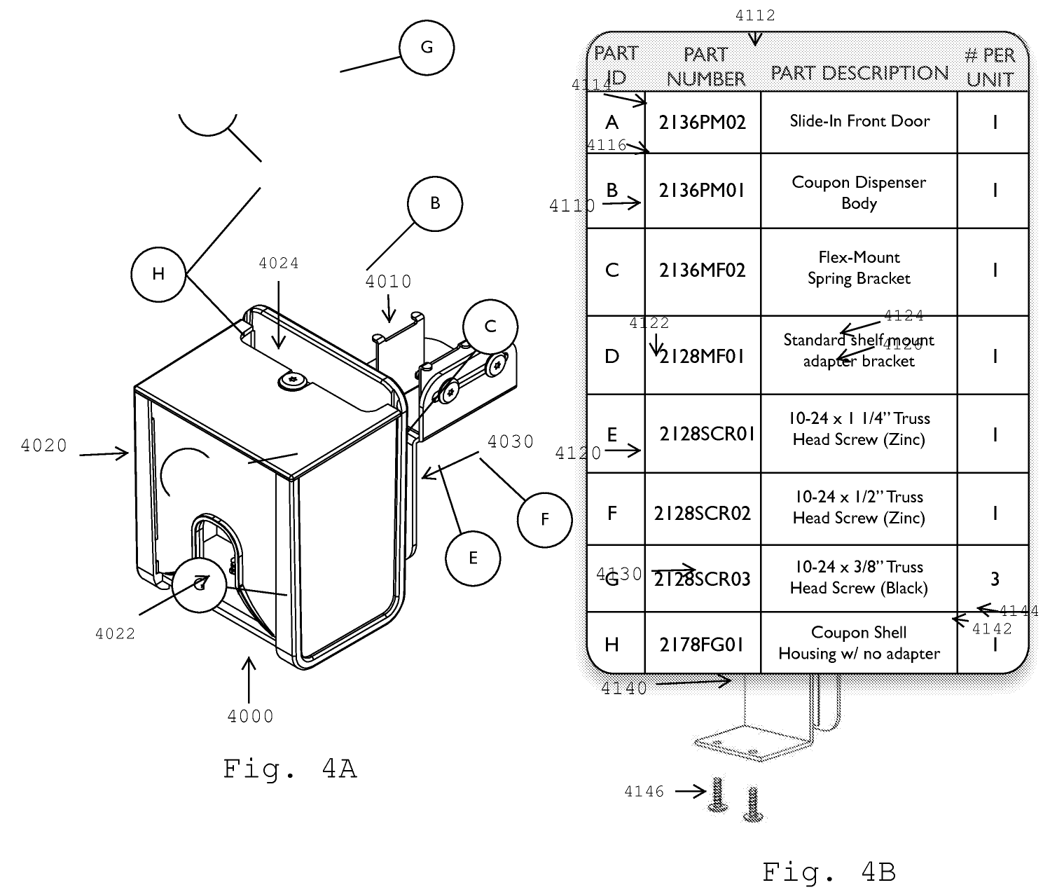

FIG. 4A is a perspective drawing of a coupon holder 4000 for mounting on the holes of a shelf. The coupon holder comprises a mounting bracket 4010, coupon dispenser 4020 and seat 4030. The coupon dispenser may comprise a dispensing opening 4022 for distributing coupons and a receiving opening 4024 for recycling unused coupons.

FIG. 4B is an exploded view of the coupon dispenser of FIG. 4A. The coupon holder comprises a body 4120 and a lid 4110. In operation, coupons are loaded into the body and the lid is slid into corresponding channels 4122 in the body. A screw 4112 secures the lid in place. The screw may have a custom shaped key hole to minimize the risk of an unauthorized person using a conventional screw driver (e.g. Phillips head) to open the dispenser and taking all of the coupons. Graphic panels 4114, 4124 may be provided to slip into corresponding channels 4116, 4126.

The coupon holder may be secured to the seat 4140 using screws 4146. These screws and all other screws in this assembly or other assemblies described herein may also have said custom shaped key hole to reduce the risk of unauthorized removal.

The seat may be secured to the mounting bracket 4130 using a long bracket screw 4142 and shorter positioning screw 4144 in a similar manner to the sign holder discussed with reference to FIGS. 2A and 2B.

The seat may alternatively be mounted an L-shaped mounting bracket such as the one illustrated in FIG. 3 and discussed above.

### Sign Holder for Mounting on a Smooth Door

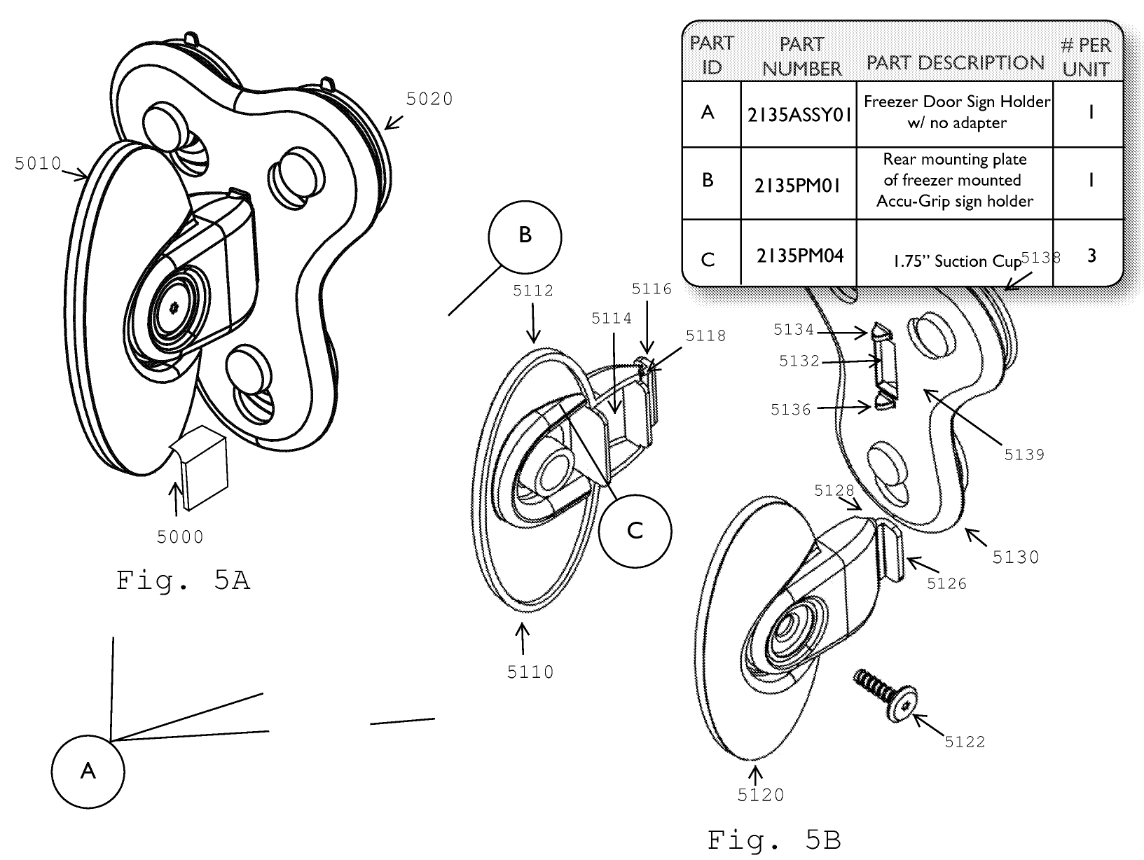

FIG. 5A is a perspective view of a sign holder 5000 that can be mounted on a smooth door, such as a freezer door in a food store. The sigh holder comprises short armed grippers 5010 and a suction cup mount 5020.

FIG. 5B is an exploded view of the freezer door sign holder of FIG. 5A. The short armed gripper comprises an engagement half 5110 and a mounting half 5120. The dimensions and aesthetic appearance of the grippers may be matched to that of shelf mounted sign holders provided to the same store. See FIG. 2A. This helps present a uniform appearance for the use of both types in the same store. The other functional features of the shelf mounted grippers discussed above, such as the elastomeric pad and mounting pins, and threaded screw barrel may also be present in the short arm grippers of FIGS. 5A and 5B.

Referring back to FIG. 5B, the engagement half comprises a gripper oval 5112 and a foam pad chamber 5114. A compressible foam pad fits into the foam pad chamber and serves to push the two halves of the gripper apart when the clamping screw 5122 is loosened.

The rear of the engagement half and the rear of the mounting half comprise outward facing L-tabs 5116 and 5126. Notches 5118 and 5128 are also provided in the top and bottom of the rear of the gripper arms.

The engagement half and mounting half are mounted on the suction cup mount 5130 by placing the L-tabs in a corresponding slot 5132 in the suction cup mount. The halves are then rotated together and the clamping screw is screwed in. The notches fit over corresponding nubs 5134, 5136 on each side of the slot. This adds greater stability to the position of the grippers.

The sign holder is then mounted on a smooth door using suction cups 5138.

The face 5139 of the suction cup mount may be made of clear plastic to match the aesthetics of a glass freezer door. The suction cups may be made of a clear elastomer for similar aesthetic considerations. Other appearances and colors may be used in other applications.

### C-Channel Mounting Bracket for Short Armed Sign Grippers

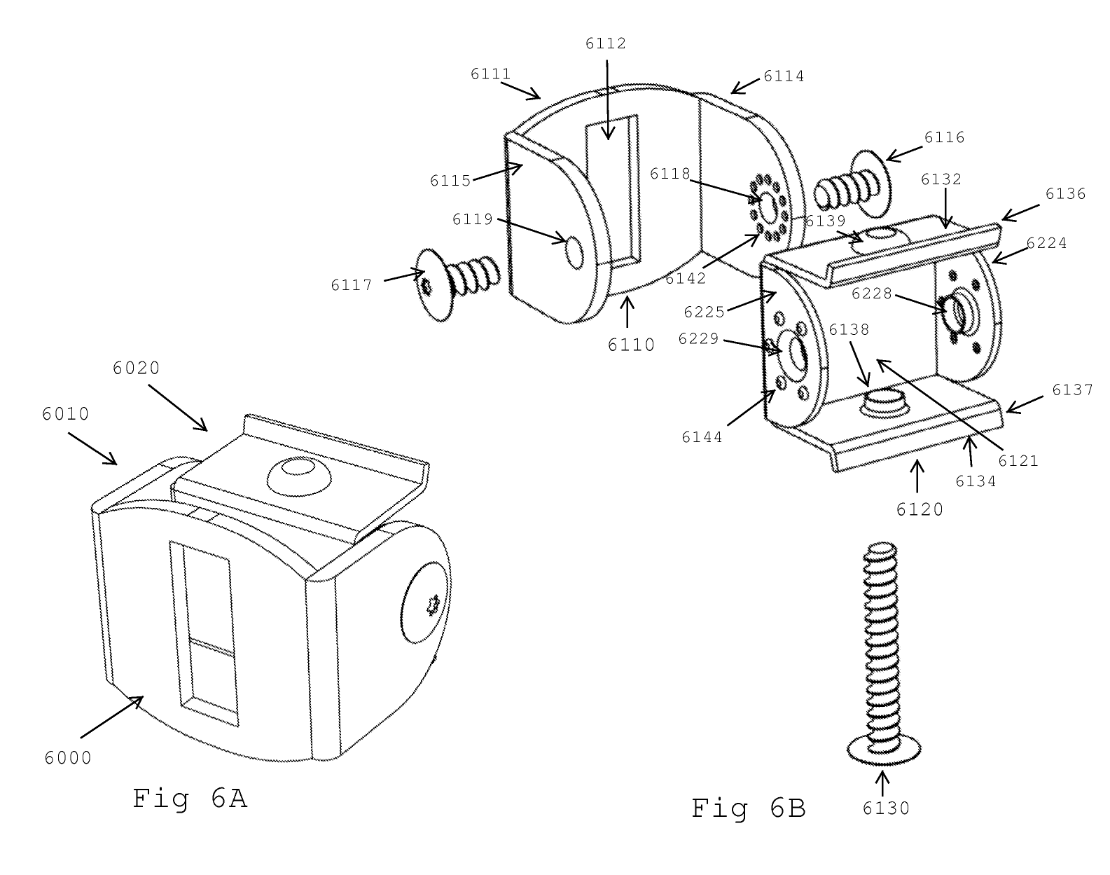

FIG. 6A is a perspective view of a C-channel mounting bracket 6000 that is suitable for the short armed sign grippers illustrated in FIG. 5A. The C-channel mounting bracket is mounted on the C-channel commonly found on the edge of the shelves in many food stores. See item 1014, FIG. 1. These C-channels normally hold signage related to the products on the shelves.

The C-channel mounting bracket comprises a mounting face 6010 and a channel anchor 6020. The mounting face receives the short armed grippers in a similar manner to the suction cup mount of FIG. 5A. The channel anchor is used to attach the mount to the C-channel on a store shelf. The face and anchor are pivotably joined together so that the angle therebetween can be adjusted. The pivotal joint can also be locked in position once the desired angle is selected. Screw type pivot mounts are illustrated, but any sort of lockable pivot, such as a rivet with a clamp, may also be used.

FIG. 6B is an exploded view of the C-channel mounting bracket of FIG. 6A. The mounting face 6110 comprises a mounting surface 6111 and two U-arms 6114, 6115 extending in parallel from each side of said mounting surface. Said mounting surface and U-arms may have aesthetically pleasing curved edges. A slot 6112 is provided in said mounting surface to receive the L-shaped tabs of the short armed grippers to be mounted therein. The thickness of the mounting surface may be matched to the thickness of the corresponding face of a suction cup mount (5139, FIG. 5B) provided to the same store. Thus the same short armed grippers may be used on the C-channel mounts of FIG. 6A and on the smooth door mounts of FIG. 5A. Suitable materials of construction for the mounting face include powder coated steel or other materials of suitable strength and aesthetics, such as high strength plastic.

The channel anchor 6120 has an open box shape. Said channel anchor comprises a bottom 6121, two pivot tabs 6224, 6225 extending in parallel from said bottom and two channel tabs 6132, 6134 also extending in parallel from said bottom. Said pivot tabs are dimensioned to fit within the corresponding U-arms of the mounting face. First and second mounting screws 6116, 6117 pass through first and second holes 6118, 6119 in the U-arms to engage first and second threaded holes 6228, 6229 in the channel anchor pivot tabs. Dimples 6142 may be provided on the inside surface of the U-arms. These correspond to bumps 6144 provided on the outside surface of the channel anchor pivot tabs. Thus the angle of the mounting face relative to a C-channel anchor can be adjusted when the mounting screws are loosened. The angle can then be locked into place when the mounting screws are tightened and the bumps and dimples engage. Bumps and dimples need only be provided on one U-arm and corresponding pivot tab. A minimum of one bump and dimple is effective. The bumps and dimples can be switched between the pivot tabs and U-arms.

Other means of securing the relative angle may be provided, such as the use of lock washers. Alternative pivot tab configurations may also be used, such as pivot tabs that face forwards.

The channel anchor additionally comprises an upper channel tab 6132 and a lower channel tab 6134. The channel tabs are bent to form lips 6136, 6137. The lips face away from each other and will normally fit into the corresponding C-channel on a shelf.

To lock the anchor in place, a set screw 6130 is screwed into a threaded set screw hole 6138 provided in the lower channel tab. The set screw is longer than the spacing between the channel tabs. After the anchor is placed in a C-channel, the set screw is screwed in until it engages the upper channel tab and pushes the two channel tabs apart. This secures the channel anchor in the C-channel of the shelf. A dimple 6139 may be provided in the upper channel tab to receive the end of the set screw. This will allow a relatively large spreading force to be provided without causing the set screw to creep to the side. The dimple is aligned with the threaded set screw hole.

To remove a channel anchor from a C-channel, the set screw is loosened and the channel tabs spring back together so that the lips clear the C-channel in the shelf.

A suitable material for the channel anchor is stainless steel. Other materials of comparable strength, elasticity and appearance may be used.

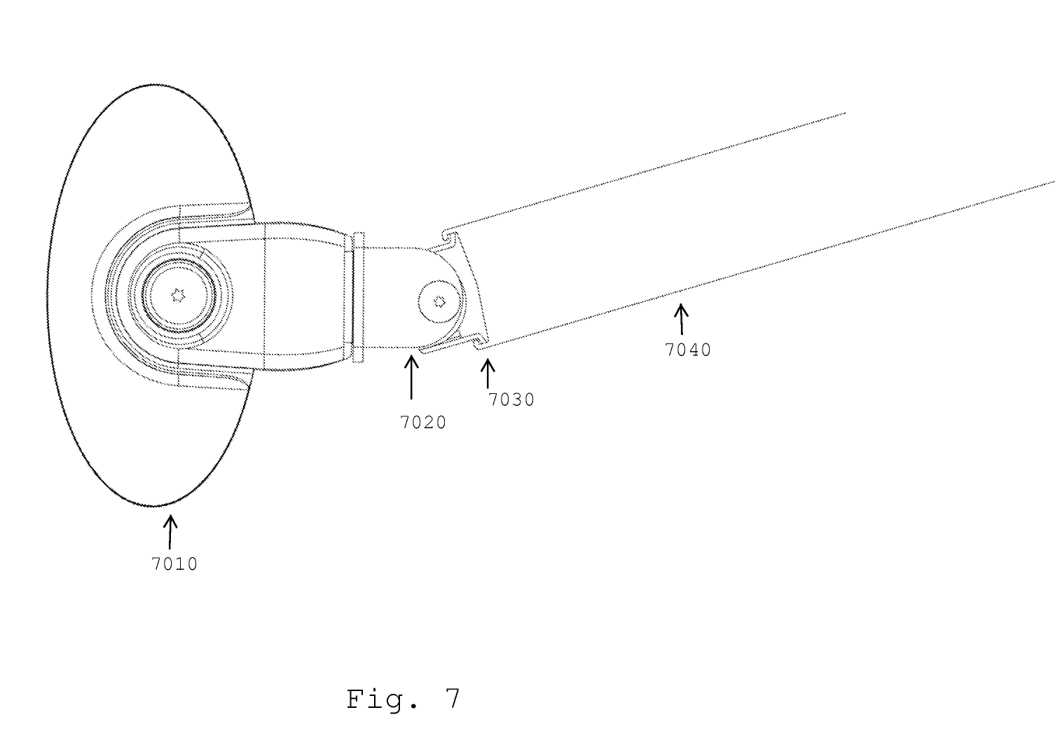

FIG. 7 is a side view of the combination of a short armed gripper 7010 mounted on a C-channel mount 7020 which in turn is mounted on a C-channel 7030 on a tilted shelf 7040.

In an alternative embodiment, the mounting face of the C-channel anchor and the mounting half of the short armed gripper may be made of a unitary piece of molded plastic.

### CONCLUSION

While the disclosure has been described with reference to one or more different exemplary embodiments, it will be understood by those skilled in the art that various changes may be made and equivalents may be substituted for elements thereof without departing from the scope of the disclosure. In addition, many modifications may be made to adapt to a particular situation without departing from the essential scope or teachings thereof. Therefore, it is intended that the disclosure not be limited to the particular embodiment disclosed as the best mode contemplated for carrying out this disclosure.

I claim:

1. A system for mounting a sign on a store shelf, said system comprising a C-channel mounting bracket, said C-channel mounting bracket comprising:
a. a mounting face, said mounting face comprising;
i. a mounting surface; and
ii. a first U-arm and a second U-arm, wherein said U-arms extend in parallel from said mounting surface and wherein a first hole is provided in said first U-arm and a second hole is provided in said second U-arm; and
b. a channel anchor, wherein said channel anchor has an open box shape and wherein said channel anchor comprises;
i. a bottom;
ii. a first pivot tab and a second pivot tab wherein said pivot tabs extend in parallel from said bottom and wherein a first threaded hole is provided in said first pivot tab and a second threaded hole is provided in said second pivot tab; and
iii. an upper channel tab and a lower channel tab wherein said upper and lower channel tabs extend in parallel from said bottom and wherein a third threaded hole is provided in said lower channel tab; and
iv. a first mounting screw and a second mounting screw; and
v. a set screw wherein said set screw is longer than the spacing between said upper and lower channel tabs;
wherein said channel anchor is mounted within said mounting face such that said first threaded hole lines up with said first hole and said second threaded hole lines up with said second hole and wherein said first mounting screw is placed through said first hole and screwed into said first threaded hole and said second mounting screw is placed through said second hole and screwed into said second threaded hole and wherein said set screw is screwed into said third threaded hole.

2. The system of claim 1 wherein:
a. said first U-arm comprises one or more dimples; and
b. said first pivot tab comprises one or more bumps;
wherein said bumps are dimensioned to engage said dimples when said first mounting screw is tightened.

3. The system of claim 1 wherein:
a. said first U-arm comprises one or more bumps; and
b. said first pivot tab comprises one or more dimples;
wherein said bumps are dimensioned to engage said dimples with said first mounting screw is tightened.

4. The system of claim 1 wherein:
a. said first channel tab comprises a first lip; and
b. said second channel tab comprises a second lip
wherein said first lip and said second lip face away from each other.

5. The system of claim 1 wherein said upper channel tab comprises a dimple and wherein said dimple aligns with said third threaded hole in said lower channel tab.

6. The system of claim 1 which further comprises:
a. a mounting half of a short armed signed gripper which comprises a first L-tab; and
b. an engagement half of a short armed signed gripper which comprises a second L-tab wherein said first L-tab faces away from said second L-tab when said mounting half is placed next to said engagement half; and
wherein a slot is provided in said mounting surface and wherein said slot is dimensioned to receive said first and second L-tabs and hold them in a fixed orientation when said mounting half and said engagement half are placed together.
